(19) United States
(12) Patent Application Publication
(10) Pub. No.: US 2017/0251070 A1
(43) Pub. Date: Aug. 31, 2017

(54) Multiple User Interest Profiles

(71) Applicant: GOOGLE INC., Mountain View, CA (US)

(72) Inventors: Zhenzhen Liu, Santa Clara, CA (US); Shankar R. Ponnekanti, Mountain View, CA (US)

(73) Assignee: GOOGLE INC., Mountain View, CA (US)

(21) Appl. No.: 13/843,944

(22) Filed: Mar. 15, 2013

(51) Int. Cl. G06Q 30/02

(52) U.S. Cl. CPC H04L 67/22; G06Q 30/0255

(57) ABSTRACT

Systems, methods performed by data processing apparatus and computer storage media encoded with computer programs for maintaining, for a user, multiple user interest profiles, each user interest profile corresponding to a different category and containing information relating to the user's online activities; receiving a request for an item of content to be presented to the user in connection with information to be displayed by a device associated with the user; determining a context of the displayed information; identifying at least two of the user's user interest profiles belonging to respective categories that are relevant to the determined context; choosing the content item to be presented to the user based at least in part on information in the identified at least two user interest profiles; and causing the chosen content item to be delivered for presentation to the user.

### BACKGROUND

This specification relates to providing digital content items (e.g., advertisements and/or other types of presentations) to users in a display environment.

Resource providers (e.g., publishers such as web site publishers) may include content such as sponsored content in their respective publications. Some resource providers do not maintain a content sponsoring (e.g., advertising) infrastructure, and thus use third party content sponsor serving companies to recruit content sponsors and to serve content items to the resource providers' sites. Third party content sponsor serving companies can, depending on various factors, control which content items are displayed to which users and under what circumstances. For example, a content sponsor serving company can provide directed content items, such as advertisements, to identified groups of users. Content items, such as advertisements, can be directed to a user by selecting suitable or appropriate content based on that user's user interest profile.

### SUMMARY

In general, one aspect of the subject matter described in this specification may be embodied in systems, methods performed by data processing apparatus and computer storage media encoded with computer programs that include the actions of maintaining, for a user, a plurality of user interest profiles, each user interest profile corresponding to a different category and containing information relating to the user's online activities; receiving a request for an item of content to be presented to the user in connection with information to be displayed by a device associated with the user; determining a context of the displayed information; identifying at least two of the user's user interest profiles belonging to respective categories that are relevant to the determined context; choosing the content item to be presented to the user based at least in part on information in the identified at least two user interest profiles; and causing the chosen content item to be delivered for presentation to the user.

In general, another aspect of the subject matter described in this specification may be embodied in systems, methods performed by data processing apparatus and computer storage media encoded with computer programs that include the actions of maintaining, for a user, a plurality of user interest profiles, each user interest profile corresponding to a different category and containing information relating to the user's online activities over a predetermined period of time; determining a context of information to be presented by a device associated with the user; attempting to identify one or more of the user's user interest profiles belonging to respective categories that are relevant to the determined context; and either (i) updating the identified one or more user interest profiles based on signals collected from the information presented by the device, or (ii) creating one or more new profiles if no existing profiles were identified.

Details of one or more implementations of the subject matter described in this specification are set forth in the accompanying drawings and the description below. Other features, aspects, and potential advantages of the subject matter will become apparent from the description, the drawings, and the claims.

### BRIEF DESCRIPTION OF THE DRAWINGS

FIG. 1 is an example network diagram.

FIG. 2 is block diagram showing examples of multiple user interest profiles corresponding to a particular user.

FIG. 3 is a flowchart of an example process for using multiple user interest profiles for a particular user.

FIG. 4 is a flowchart of an example process for building and/or updating multiple user interest profiles with regard to a particular user.

FIG. 5 is a block diagram of examples of computing devices that may be used to implement the systems and methods described in this document_{;} as either a client or as a server or plurality of servers.

Like reference numbers and designations in the various drawings indicate like elements.

### DETAILED DESCRIPTION

In general, the subject matter of this specification relates to generating and using for each user multiple different user interest profiles, each potentially corresponding to a different category, for example, grouped according to subject matter, time periods, publisher identity, or essentially any other appropriate grouping. A user interest profile can be generated based on inferred user interests and/or inferred user demographics. The inferred user interests and demographics can be derived from events that occurred during the user's online activities, for example, by aggregating signals (e.g., keywords) appearing on web pages visited by the user. An event is an action that occurs during a user session—such as a web page view, an advertisement click-through, and/or a conversion—and tends to be indicative of the user's interest (or lack of interest) in a particular web page or portion thereof. For example, a user's interests can be inferred from the subject matter of the one or more topics (e.g., cars, finance, sports, shopping, etc.) to which the events of that user's online activities correspond. Additionally, the level of activity as measured by the number of events belonging to a given topic can also be used to measure a level of user interest.

The user demographics for a user can be inferred from sites the user visited during the user's online activities. Each inferred demographic can be determined based on an aggregation of the known demographic features from the sites visited by the user. Typically, the user interest profile for a given user is constructed from the inferred user interests and inferred user demographics, and is used to customize advertisements to user sessions associated with that user.

In general, a user's short-term web browsing history, which for example contains web pages visited by the user within the last 30 minutes, may be used to construct that user's user interest profile because the user's short-term web browsing history, which tends to center around a coherent topic, also tends to be a better predictor of what the user is likely to be interested in at the current moment. Alternatively, the user's long-term web browsing history (e.g., web pages visited by user over the last day or week) can be used to generate the user interest profile, even though a user's long term browser history tends to include non-coherent topics and/or noisy signals. In either case, the generated user interest profile is used to identify (or adjust) a set of candidate digital content items (e.g., advertisements)—that is, digital content items that are candidates for display to the user. Digital content items/advertisements that are presented for a user session are selected from the set of candidates that were identified/adjusted based on the user interest profile.

When using a user's long-term browsing history to create that user's user interest profile, the user interest profile so created tends to include an abundance of noisy information that is, a lot of disparate, unrelated signals. This is because over a relatively long period of time—say, a week—any given user would tend to visit lots of different web pages that correspond to disparate things. Consequently, such a long-term user interest profile, while having a potential benefit over short-term user interest profiles in the amount of available information, may tend to produce anomalous results when being used to predict the user's likely current interests. Organizing those disparate, unrelated signals into multiple, category differentiated user interest profiles—which collectively define the user's potential interest across multiple different categories—and then using one or more of those profiles in a context appropriate manner to predict the user's likely current interest, may provide potential performance advantages over using just a single, monolithic user interest profile.

In situations in which the systems discussed here collect information about users, or may make use of information about users, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that certain information about the user is removed. For example, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information is collected about the user and used by a content server.”

### Example Operating Environment

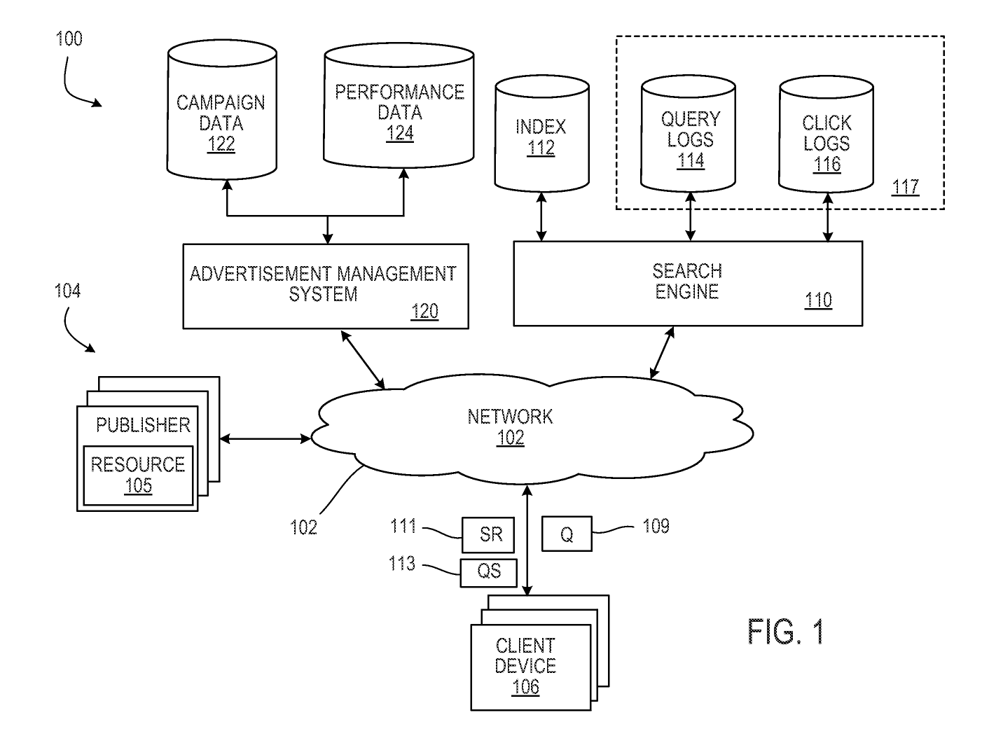

FIG. 1 is a block diagram of an example operating environment 100 in which various aspects of the subject matter described here may be implemented. A computer network 102, such as a local area network (LAN), wide area network (WAN), the Internet, or a combination thereof, connects resource provider web sites 104, user devices 106, and the search engine 110, and an advertisement management system 120. The online environment 100 may include many thousands of resource provider web sites 104 and user devices 106.

A website 104 includes one or more resources 105 associated with a domain name and hosted by one or more servers. An example website is a collection of web pages formatted in hypertext markup language (HTML) that can contain text, images, multimedia content, and programming elements, such as scripts. Each website 104 is maintained by a content resource provider, which is an entity that controls, manages and/or owns the website 104.

A resource is any data that can be provided by the resource provider 104 over the network 102 and that is associated with a resource address. Resources include HTML pages, word processing documents, and portable document format (PDF) documents, images, video, and feed sources, to name just a few. The resources can include content, such as words, phrases, pictures, and so on, and may include embedded information (such as meta information and hyperlinks) and/or embedded instructions (such as JAVASCRIPT scripts).

A user device 106 is an electronic device that is under the control of a user and is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102. The web browser can enable a user to display and interact with text, images, videos, music and other information typically located on a web page at a website on the world wide web or a local area network.

To facilitate searching of these resources 105, the search engine 110 identifies the resources by crawling the resource provider web sites 104 and indexing the resources provided by the resource provider web sites 104. The indexed and, optionally, cached copies of the resources, are stored in an index 112.

The user devices 106 submit search queries 109 to the search engine 110. Alternatively, or in addition, the user devices 106 can interact directly with website 104 without going through the search engine 110. When the search engine 110 is employed, the search queries 109 are submitted in the form of a search request that includes the search request and, optionally, a unique identifier that identifies the user device 106 that submits the request. The unique identifier can be data from a cookie stored at the user device, or a user account identifier if the user maintains an account with the search engine 110, or some other identifier that identifies the user device 106 or the user using the user device.

In response to the search request, the search engine 110 uses the index 112 to identify resources that are relevant to the queries. The search engine 110 identifies the resources in the form of search results 111 and returns the search results to the user devices 106 in search results page resource. A search result is data generated by the search engine 110 that identifies a resource that satisfies a particular search query, and includes a resource locator for the resource. An example search result can include a web page title, a snippet of text extracted from the web page, and the URL of the web page.

The search results are ranked based on scores related to the resources identified by the search results, such as information retrieval (“IR”) scores, and optionally a separate ranking of each resource relative to other resources (e.g., an authority score). The search results are ordered according to these scores and provided to the user device according to the order.

The user devices 106 receive the search results pages and render the pages for presentation to users. In response to the user selecting a search result at a user device 106, the user device 106 requests the resource identified by the resource locator included in the selected search result. The resource provider of the web site 104 hosting the resource receives the request for the resource from the user device 106 and provides the resource to the requesting user device 106.

In some implementations, the queries 109 submitted from user devices 106 are stored in query logs 114. Click data for the queries and the web pages referenced by the search results are stored in click logs 116. The query logs 114 and the click logs 116 define search history data 117 that include data from and related to previous search requests associated with unique identifiers. The click logs define actions taken responsive to search results provided by the search engine 110. The query logs 114 and click logs 116 can be used to map queries submitted by the user devices to web pages that were identified in search results and the actions taken by users (i.e., that data are associated with the identifiers from the search requests so that a search history for each identifier can be accessed). The click logs 116 and query logs 114 can thus be used by the search engine to determine the sequence of queries submitted by the user devices, the actions taken in response to the queries, and how often the queries are submitted.

The advertisement management system 120 facilitates the provisioning of content items with the resources 105. In particular, the advertisement management system 120 allows content sponsors to define rules that take into account attributes of the particular user to provide customized content items for the users. Example rules include keyword customization, in which content sponsor provide bids for keywords that are present in either search queries or webpage content. Content items that are associated with keywords having bids that result in an advertisement slot being awarded in response to an auction are selected for displaying in the advertisement slots.

When a user of a user device 106 selects an advertisement, the user device 106 generates a request for a landing page of the advertisement, which is typically a webpage of the content sponsor. For example, the resource providers 104 may include content sponsors, each having hosting respective web pages, some of which are landing pages for the content items of the content sponsors.

These customized content items can be provided for many different resources, such as the resources 105 of the resource providers 104, and on a search results page resource. For example, a resource 105 from a resource provider 104 includes instructions that cause the user device to request content items from the advertisement management system 120. The request includes a resource provider identifier and, optionally, keyword identifiers related to the content of the resource 105. The advertisement management system 120, in turn, provides customized content items to the particular user device.

With respect to a search results page, the user device renders the search results page and sends a request to the advertisement management system 120, potentially along with one or more keywords related to the query that the user provided to the search engine 110. Alternatively, or in addition, the advertisement management system 120 generates one or more keywords by parsing the content of the request URL. In any event, the advertisement management system 120, in turn, provides customized content items to the particular user device.

The advertisement management system 120 includes a data storage system that stores campaign data 122 and performance data 124. The campaign data 122 stores content items, content customization information, and budgeting information for content sponsors. The performance data 124 stores data indicating the performance of the content items that are served. Such performance data can include, for example, click through rates for content items, the number of impressions for content items, and the number of conversions for content items. Other performance data can also be stored.

The campaign data 122 and the performance data 124 are used as input parameters to an advertisement auction. In particular, the advertisement management system 120, in response to each request for content items, conducts an auction to select content items that are provided in response to the request. The content items are ranked according to a score that, in some implementations, is proportional to a value based on an advertisement bid and one or more parameters specified in the performance data 124. The highest ranked content items resulting from the auction are selected and provided to the requesting user device.

### Category Differentiated User Interest Profiles

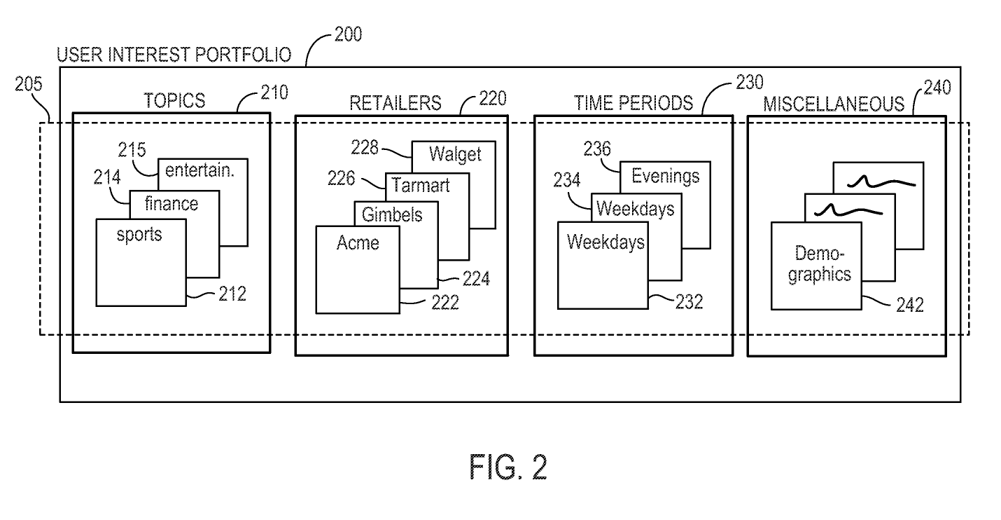

FIG. 2 is a block diagram showing examples of multiple user interest profiles corresponding to a particular user and which are organized into different categories. That is, rather than having a single, monolithic user interest profile, each user has an associated portfolio comprising multiple user interest profiles, each corresponding to a different category, which may be further divided into any arbitrary level of subcategories. In the example of FIG. 2, the user under consideration has a user interest portfolio 200 made up of multiple user interest profiles 205 that collectively describe the user's interests, demographics and the like, and which are organized into four different bins: topics 210, retailers 220, time periods 230 and miscellaneous 240. Each bin 210, 220, 230, 240 relates to user interest profiles in related categories, for example, in this user's topics bin 210, the user has user interest profiles for each of three different content-based topics, specifically, a sports profile 212, a finance profile 214 and an entertainment profile 216.

Each of the different profiles 212, 214, 216 contains signals (e.g., keywords) collected from web pages visited by the user that were determined to correspond to the associated topic. For example, assume that over a predetermined period of time (e.g., a day, week or month), the user has visited various disparate content-based web pages, some that were determined to relate to sports topics, others that were determined to relate to finance topics and still others that were determined to relate to entertainment topics. Upon visiting one of those web pages, for example, a sports-related web page, signals are collected from the page and are used to build or supplement the user's sports profile 212. Similarly, when the user visited finance-related web pages, signals were collected from those pages and used to build or supplement the user's finance profile 216. The user's entertainment profile 216 would be built and/or supplemented in a similar manner. Some pages visited by the user may be determined to relate to two or more different topics—for example, both sports and entertainment. In such cases, signals collected from a single page may be used to build and/or supplement two or more user interest profiles as appropriate.

Subsequently, one or more of the multiple user profiles can be used in a context-appropriate manner when deciding the type of digital content items (e.g., advertisements) to be presented to the user upon the user's visiting a new web page. For example, when the user visits a web page that is determined to be sports-related, the signals in the users' sports profile are used in deciding, at least in part, which advertisements (and/or other digital content items) are among the candidates for presentation to the user along with that web page. In this manner, unlike the situation in which a single, monolithic user interest profile is used to make such decisions, only those user interest profile signals that are likely to be relevant to the user's current context (e.g., the current web page being visited) are used in making the selection of which advertisements are good candidates for presentation to the user.

As shown in FIG. 2, multiple user interest profiles in categories other than content-based topics can be generated and used. For example, the user interest portfolio 200 includes a retailers bin 220 that includes four retailer profiles 222, 224, 226, 228 corresponding to online retail websites that the user has visited and/or done business with in the past, and from which signals have been collected and used to build or supplement their respective profiles. When the user next visits a web page associated with one of retailer profiles, the signals in that profile can be used in the selection of which advertisements (and/or other digital content) are good candidates for presentation to the user. Alternatively, or in addition, signals from two or more retailer profiles could be used in making the selection. For example, if the user visits a web page associated with the retailer “Acme,” then not only could signals from the user's Acme profile 222 be used but also signals from one of the other retailer profiles (e.g., the Gimbels profile 224) could be used, potentially depending on a predetermined degree of relatedness between the two retailers.

Essentially any other appropriate profile categorization could be used depending on design objectives and desired results. For example, as shown in FIG. 2, the user's user interest portfolio 200 includes a time period bin 230 of user interest profiles that are time based. Although essentially any appropriate time period could be designated and used, in this example the user's time period bin 230 includes time-based profiles corresponding to weekends 232, weekdays 234 and evenings 236. By way of example, the user's weekends profile 232 is built and/or supplemented by collecting signals from web pages visited by the user on either Saturday or Sunday. Similarly, when the user is visiting a web page on either a Saturday or a Sunday (that is, the user's context relating to that web page visit includes the fact that the current time falls on a weekend), then the user's weekends profile 232 is used—either alone or in conjunction with signals from another profile relevant to the user's current context—in selecting candidate advertisements/digital content for presentation to the user. The user's weekdays profile 234 and evenings profile 236 would be built and used in similar manners except would be triggered in their different respective contexts—that is, when the user's context included the fact the current time fell on a weekday and/or in the evenings.

Also as shown in FIG. 2, the user's user interest portfolio 200 includes a miscellaneous bin 240 which can include user interest profiles in essentially any useful and appropriate category, for example, a user profile corresponding to the user's demographics 242. As with the other user interest profiles, the user's demographics profile 242 can be used—alone or in conjunction with signals from the user's other profiles—in selecting candidate advertisements/digital content items for presentation to the user.

User interest profiles also can correspond to subcategories of other user interest profiles. For example, a user can have an entertainment profile (i.e., the profile's category is entertainment), which further can be delineated into sub-categories such as music, TV, film, video games, or the like. Further, a user interest profile corresponding to a sub-category can in turn have its own sub-categories, for example, a user's music profile could be further delineated into different types of music (e.g., jazz, classical, rock, hip-hop, etc.), each of which could be maintained and used as a separated user interest profile in the manner described herein.

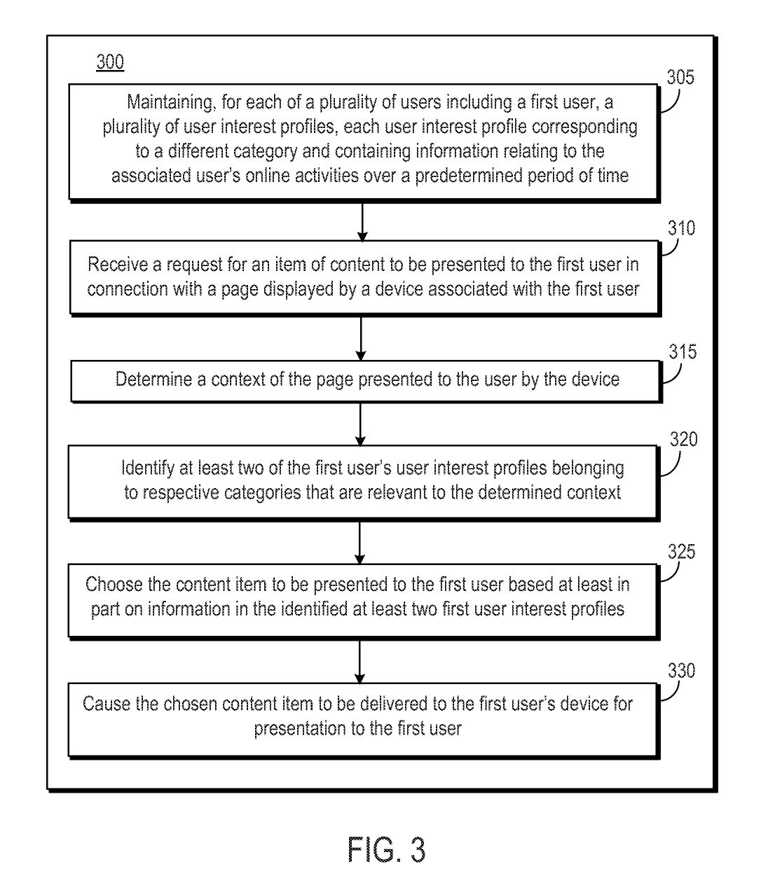

FIG. 3 is a flowchart of an example process 300 for using multiple user interest profiles for a particular user. At 305, the process maintains (or creates in the first instance if none already exists), for each of multiple users, multiple user interest profiles. Each user interest profile for a particular user corresponds to a different category (e.g,, sports, finance, a specific retailer, a specific time period) and contains information (e.g., keywords) relating to the associated user's online activities over a predetermined period of time (e.g., a day, a week, a month, etc.).

At 310, the process 300 receives a request for an item of content (e,g., an advertisement) to be presented to a particular user in connection with a page (e.g., a web page) displayed by a device associated with that user. At 315, the process 300 determines a context of the page presented by the device. The context so determined can include essentially any characteristic or parameter that is discernible or measurable about the page itself (e.g., content topics, identity of page publisher, affiliation with retailer or other entity, etc.), the device on which it is presented (e.g., screen size and resolution, hardware capabilities, location of device, etc.), the user associated with the device (e.g., known or discernible demographic information, etc.), and/or otherwise relating to the circumstances under which the page is presented (e.g., time of day/week/year at which page is being viewed, outside weather, etc.).

Next, at 320, the process 300 identifies the particular user's user interest profiles belonging to respective categories that are relevant to the particular user's determined context. For example, assume that the user was at home on a Saturday and was currently viewing a page relating to a sports topic. In that case, process 300 may determine at 315 that the user's context included the facts that (a) the currently viewed page related to sports content and (b) that the current time was a weekend. In that scenario, at 320, the process 300 may identify the user's sports portfolio 212 and the user's weekends portfolio 232 as being relevant to the user's determined context.

Next, at 325, the process 300 chooses a content item (e.g., advertisement) to be presented to the user based at least in part on information (e.g., signals such as keywords) in the identified user interest profiles. Then, at 330, the process 300 causes the chosen content item to be delivered to the user's device for presentation.

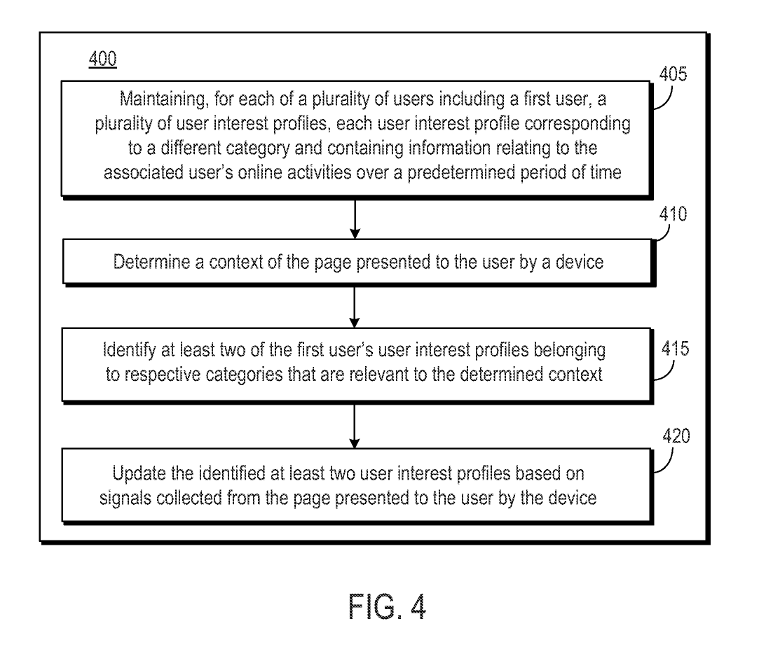

FIG. 4 is a flowchart of an example process 400 for building and/or updating multiple user interest profiles with regard to a particular user. At 405, the process maintains (or creates in the first instance if none already exists), for each of multiple users, multiple user interest profiles. Each user interest profile for a particular user corresponds to a different category (e.g., sports, finance, a specific retailer, a specific time period) and contains information (e.g., keywords) relating to the associated user's online activities over a predetermined period of time (e.g., a day, a week, a month, etc.).

At 410, the process 400 determines a context of the page presented by the device. As noted above, the context so determined can include essentially any characteristic or parameter that is discernible or measurable about the page itself (e.g., content topics, identity of page publisher, affiliation with retailer or other entity, etc.), the device on which it is presented (e.g., screen size and resolution, hardware capabilities, location of device, etc.), the user associated with the device (e.g., known or discernible demographic information, etc.), and/or otherwise relating to the circumstances under which the page is presented (e.g., time of day/week/year at which page is being viewed, outside weather, etc.). Next, at 415, the process 400 identifies two or more of the user's user interest profiles belonging to respective categories that are relevant to the particular user's determined context. For example, assume the process 400 determines that context of the page presented by the device includes the following facts: (a) the page relates to sports, (b) the page also relates to entertainment, (c) the page was visited by the user on a Sunday, and (d) demographic information about the user can be inferred from the page's content. Accordingly, in that scenario, process 400 may identify at least four of the user's user interest profiles as being relevant to the determined context, namely, the user's sports profile 212, entertainment profile 216, weekends profile 232, and demographics profile 242.

At 420, the process 400 updates each of the user interest profiles identified at 415 as belonging to categories that are relevant to the determined context. if a user interest profile relating to an identified category does not yet exist, the process 400 would create it anew in the first instance before updating it. Updating a user interest profile typically would involve adding appropriate information—that is, information descriptive of and/or relating to the determined context—to the profile. For example, if the determined context included the fact that the page related to sports, then the user's sports profile would be updated by adding sports-related keywords collected from the page to the profile. Similarly, if the determined context included the fact that demographic information about the user could be inferred from the page, then the demographic information so inferred would be added to the user's demographics profile.

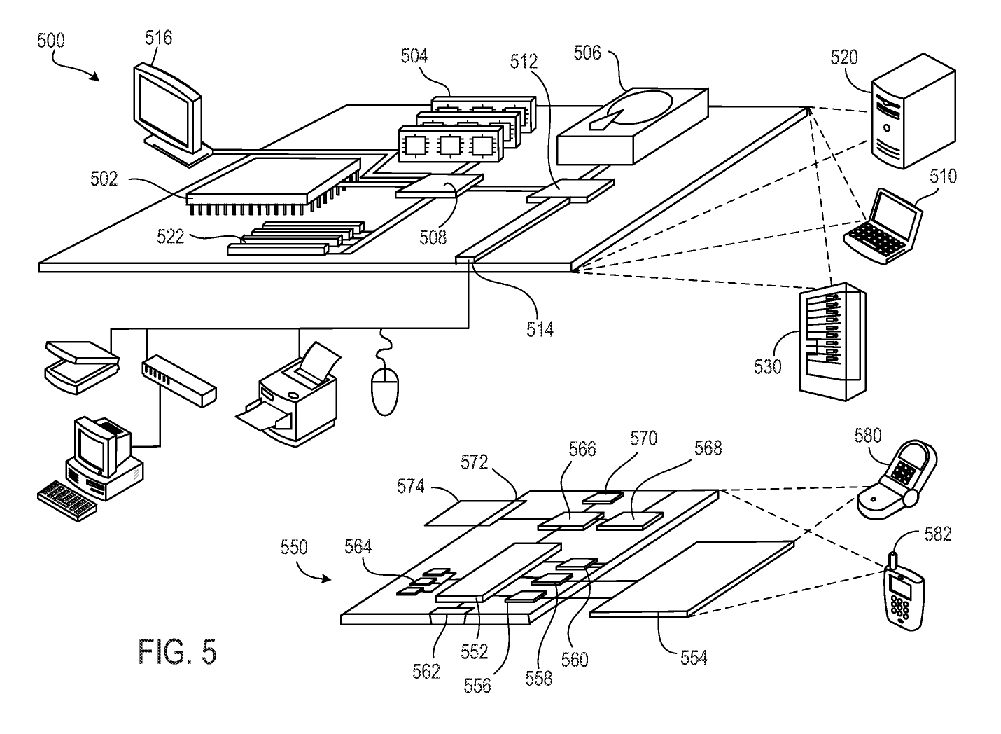

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. Additionally computing device 500 or 550 can include Universal Serial Bus (USB) flash drives. The USB flash drives may store operating systems and other applications, The USB flash drives can include input/output components, such as a wireless transmitter or USB connector that may be inserted into a USB port of another computing device. The components shown here, their connections and relationships, and their functions, are meant to be illustrative only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is illustrative only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a mnicrodrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. Additionally, the processor may be implemented using any of a number of architectures. For example, the processor 410 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552 that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others, Such communication may occur, for example, through radio-frequency transceiver 568. In addition, short-range communication may occur, such as using a Bluetooth, WiFi, or other such transceiver (not shown), In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smnartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. Moreover, other mechanisms for detecting impersonation on a social network may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

1. A method performed by one or more data processing apparatus, the method comprising:
accessing a single user's long-term web browsing history including disparate content-based web pages that the user has visited over a predetermined period of time, the predetermined period of time including multiple different user sessions that occur over more than a week;
selectively grouping the disparate content-based web pages into subsets of web pages, the subsets of web pages being related to various different topics;
extracting keywords related to the various different topics from the subsets of web pages;
creating, for the user, a plurality of user interest profiles, the plurality of user interest profiles being organized into different categories, each user interest profile of the plurality of user interest profiles corresponding to a particular topic and containing keywords extracted from a subset of web pages related to that particular topic;
after creating the plurality of user interest profiles for the user:
receiving a request for an item of content to be presented to the user with a given web page that is being displayed by a device associated with the user;
determining a context of the given web page including (i) determining a given topic of the given web page and (ii) determining a day of week when the request is received and the given web page is being displayed;
identifying, in response to the request, fewer than all of the plurality of user interest profiles of the user that are related to some of the various different topics that are relevant to the determined given topic of the given web page and created for the determined day of the week when the request is received and the given web page is being displayed;
choosing the content item to be presented to the user based at least in part on a set of keywords contained in the fewer than all of the plurality of user interest profiles of the user, wherein the set of keywords include fewer than all of the keywords extracted from all of the subsets of web pages; and
causing the chosen content item to be delivered for presentation to the user.

2. The method of claim 1 wherein one of the identified fewer than all of the plurality of user interest profiles comprises a time-based user interest profile.

3. The method of claim 2 wherein another of the identified fewer than all of the plurality of user interest profiles comprises one or more of a topic-based user interest profile, a retailer-based user interest profile, or a demographics user interest profile.

4. The method of claim 1 wherein choosing the content item comprises selecting an advertisement.

5. (canceled)

6. (canceled)

7. The method of claim 1 wherein determining the context of the given web page further comprises one or more of identifying the given web page as corresponding to a particular retailer or identifying demographic information that can be inferred from the given web page.

8. The method of claim 1 wherein determining the day of the week when the request is received and the given web page is being displayed comprises determining whether the day of the week is a weekend day.

9. The method of claim 1 wherein choosing the content item to be presented to the user based at least in part on the sets of keywords contained in the identified fewer than all of the plurality of user interest profiles of the user comprises using the keywords contained in the fewer than all of the plurality of user interest profiles of the user to influence an outcome of an advertisement auction.

10. The method of claim 9 wherein receiving a request for the content item comprises receiving a request for an advertisement and wherein causing the chosen content item to be delivered to the user's device for presentation to the user comprises causing an advertisement chosen as a result of the advertisement auction to be returned to the user's device.

11. The method of claim 1 further comprising updating one or more of the plurality of user interest profiles of the user based on keywords collected from the given web page.

12. A method performed by one or more data processing apparatus, the method comprising:
accessing a single user's long-term web browsing history including disparate content-based web pages that the user has visited over a predetermined period of time, the predetermined period of time including multiple different user sessions that occur over more than a week;
selectively grouping the disparate content-based web pages into subsets of web pages, the subsets of web pages being related to various different topics;
extracting keywords related to the various different topics from the subsets of web pages;
creating, for the user, a plurality of user interest profiles, the plurality of user interest profiles being organized into different categories, each user interest profile of the plurality of user interest profiles corresponding to a particular topic and containing keywords extracted from a subset of web pages related to that particular topic;
determining a context of a given web page to be presented by a device associated with the user including (i) determining a given topic of the given web page and (ii) determining a day of week when the request is received and the given web page is being displayed;
identifying, in response to the request, fewer than all of the plurality of user interest profiles of the user that are related to some of the various different topics that are relevant to the determined given topic of the given web page and created for the determined day of the week when the request is received and the given web page is being displayed; and
either (i) updating the identified fewer than all of the plurality of user interest profiles of the user based on keywords collected from the given web page presented by the device, or (ii) creating one or more new user interest profiles if no existing profiles were identified.

13. A system comprising:
a processor configured to execute computer program instructions; and
a computer storage medium encoded with computer program instructions that, when executed by the processor, cause the system to perform operations comprising:
accessing a single user's long-term web browsing history including disparate content-based web pages that the user has visited over a predetermined period of time, the predetermined period of time including multiple different user sessions that occur over more than a week;
selectively grouping the disparate content-based web pages into subsets of web pages, the subsets of web pages being related to various different topics;
extracting keywords related to the various different topics from the subsets of web pages;
creating, for the user, a plurality of user interest profiles, the plurality of user interest profiles being organized into different categories, each user interest profile of the plurality of user interest profiles corresponding to a particular topic and containing keywords extracted from a subset of web pages related to that particular topic;
after creating the plurality of user interest profiles for the user:
receiving a request for an item of content to be presented to the user in connection with a given web page that is being displayed by a device associated with the user;
determining a context of the given web page including (i) determining a given topic of the given web page and (ii) determining a day of week when the request is received and the given web page is being displayed;
identifying, in response to the request, fewer than all of the plurality of user interest profiles of the user that are related to some of the various different topics that are relevant to the determined given topic of the given web page and created for the determined day of the week when the request is received and the given web page is being displayed;
choosing the content item to be presented to the user based at least in part on a set of keywords contained in the fewer than all of the plurality of user interest profiles of the user, wherein the set of keywords include fewer than all of the keywords extracted from all of the subsets of web pages; and
causing the chosen content item to be delivered for presentation to the user.

14. The system of claim 13 wherein one of the fewer than all of the plurality of user interest profiles of the user comprises a time-based user interest profile, a topic-based user interest profile, a retailer-based user interest profile, or a demographics user interest profile.

15. The system of claim 13 wherein choosing the content item comprises selecting an advertisement.

16. (canceled)

17. The system of claim 13 wherein determining the context of the given web page further comprises one or more of identifying the given web page as corresponding to a particular retailer or identifying demographic information that can be inferred from the given web page.

18. The system of claim 13 wherein choosing the content item to be presented to the user based at least in part on the sets of keywords contained in the identified fewer than all of the plurality of user interest profiles of the user comprises using the keywords contained in the fewer than all of the plurality of user interest profiles of the user to influence an outcome of an advertisement auction.

19. The system of claim 18 wherein receiving a request for the content item comprises receiving a request for an advertisement and wherein causing the chosen content item to be delivered to the user's device for presentation to the user comprises causing an advertisement chosen as a result of the advertisement auction to be returned to the user's device.

20. The system of claim 13 further comprising updating one or more of the plurality of user interest profiles of the user based on keywords collected from the given web page.
